(19) United States
(12) Patent Application Publication
(10) Pub. No.: US 2025/0225984 A1
(43) Pub. Date: Jul. 10, 2025

(54) OFFLINE VOICE RECOGNITION FOR CONSUMER PRODUCTS

(71) Applicant: Jem Accessories Inc., Edison, NJ (US)

(72) Inventors: Elie CHEMTOB, Eatontown, NJ (US); Isaac KROUB, Deal, NJ (US); Alexa SAHADI, Montclair, NJ (US)

(73) Assignee: Jem Accessories Inc., Edison, NJ (US)

(21) Appl. No.: 19/010,442

(22) Filed: Jan. 6, 2025

Related U.S. Application Data
(60) Provisional application No. 63/618,346, filed on Jan. 7, 2024.

(51) Int. Cl. G10L 15/22; G10L 15/14; G10L 25/30

(52) U.S. Cl. CPC G10L 15/22; G10L 15/142; G10L 25/30; G10L 2015/223

(57) ABSTRACT

There is provided a component for providing offline voice recognition capabilities for operating a device, comprising: a memory configured to store a text file including at least one command for operating the device, a microphone, and circuitry in communication with the memory and the microphone, the circuitry configured for: extracting features from audio signals generated by the microphone, comparing the features to the at least one command of the text file stored by the memory, and in response to a match between the features and the at least one command, generating instructions for operating the device according to the at least one command.

### RELATED APPLICATION(S)

This application claims the benefit of priority under 35 USC § 119 (e) of U.S. Provisional Patent Application No. 63/618,346 filed on Jan. 7, 2024, the contents of which are incorporated by reference as if fully set forth herein in their entirety.

### BACKGROUND

The present invention, in some embodiments thereof, relates to voice recognition and, more specifically, but not exclusively, to voice recognition built into consumer products.

Voice recognition, also referred to as voice command technology, or speed recognition technology, refers to the capability of a system to interpret and understand spoken language. The primary goal of this technology is to enable users to interact with devices, applications, and services using their voice, rather than traditional input methods such as typing or touching.

### SUMMARY

According to a first aspect, a component for providing offline voice recognition capabilities for operating a device, comprises: a memory configured to store a text file including at least one command for operating the device, a microphone, and circuitry in communication with the memory and the microphone, the circuitry configured for: extracting features from audio signals generated by the microphone, comparing the features to the at least one command of the text file stored by the memory, and in response to a match between the features and the at least one command, generating instructions for operating the device according to the at least one command.

According to a second aspect, a method of providing offline voice recognition capabilities for operating a device, comprises: extracting features from audio signals generated by a microphone, comparing the features to at least one command of a text file stored by a memory physically connected to the device, and in response to a match between the features and the at least one command, generating instructions for operating a controller of the device according to the at least one command.

According to a third aspect, a non-transitory medium storing program instructions for providing offline voice recognition capabilities for operating a device, which when executed by at least one processor, causes the at least one processor to: extract features from audio signals generated by a microphone, compare the features to at least one command of a text file stored by a memory physically connected to the device, and in response to a match between the features and the at least one command, generate instructions for operating a controller of the device according to the at least one command.

In a further implementation form of the first, second, and third aspects, comparing comprises measuring similarity between the features and the at least one command, and the match comprises the measured similarity is greater than a threshold and/or according to a requirement.

In a further implementation form of the first, second, and third aspects, the component excludes a network interface.

In a further implementation form of the first, second, and third aspects, the component includes a data interface for point to point communication between the component and a controller of the device.

In a further implementation form of the first, second, and third aspects, the data interface is physically wired to the controller of the device.

In a further implementation form of the first, second, and third aspects, the data interface is a serial interface.

In a further implementation form of the first, second, and third aspects, the device comprises at least one of: a consumer product and a home device.

In a further implementation form of the first, second, and third aspects, the device is selected from: coffee maker, heater, fan, vacuum, light, diffuser, radio, oven, speaker, audio device, video device, television, personal care devices, and air conditioners.

In a further implementation form of the first, second, and third aspects, the component is integrated with a controller of the device as an embedded system installed within the device.

In a further implementation form of the first, second, and third aspects, the circuitry is further configured for implementing a neural network that generates an embedding in response to an input of the audio signals, the extracted features include the embedding.

In a further implementation form of the first, second, and third aspects, the neural network is trained on a training dataset of multiple sample audio signals from a plurality of individuals referring to a plurality of different identifiers of devices and/or a plurality of different commands for operating the device.

In a further implementation form of the first, second, and third aspects, the memory is further configured to store a second text file including at least one identifier of the device, wherein circuitry is further configured for comparing to features to the at least one identifier of the device, and in response to a match between the features and the at least one identifier, performing the comparison between the features and the at least one command.

In a further implementation form of the first, second, and third aspects, further comprising circuitry for extracting features from the text file, wherein the comparison is done by comparing the features extracted from the audio signals to features extracted from the text file.

In a further implementation form of the first, second, and third aspects, features are extracted from the audio signals as embeddings arranged into a first vector outputted by a neural network, and features are extracted from the text file as a second vector, and the comparison is performed by computing a distance between the first vector and the second vector, and evaluating the distance according to a threshold or requirement.

In a further implementation form of the first, second, and third aspects, at least one of the extracted features includes Mel Frequency Cepstral Coefficients (MFCCs) computed by applying a Mel filterbank to a power spectrum representation of the audio signal, computing a logarithm of the outcome of applying the Mel filterbank, and applying a discrete cosine transform (DCT) to obtain the MFCCs, wherein the MFCCs are compared to the text file.

In a further implementation form of the first, second, and third aspects, the comparison is performed by computing a dynamic time warping (DTW) of the audio signal and the text file for alignment of the audio signal with the text file for matching the aligned audio signal and text file by measuring similarity between temporal sequences of the matched aligned audio signal and text file varying in speed.

In a further implementation form of the first, second, and third aspects, the circuitry is further configured to implement a Hidden Markov Model (HMM) that obtains at least one observation in response to an input of the audio signals, and matching comprises assigning the at least one command to the at least one observation according to patterns extracted from the data.

In a further implementation form of the first, second, and third aspects, the text file includes at least 5 different commands for operating the device.

In a further implementation form of the first, second, and third aspects, circuitry is further configured for digitizing an analogue signal obtained from the microphone, wherein the features are extracted from the digitized analogue signal.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of a system comprising a device and a component designed for providing offline voice recognition capabilities for operating device 104, in accordance with some embodiments of the present invention;

FIG. 2 is a flowchart of a method for providing offline voice recognition capabilities for operating a device, in accordance with some embodiments of the present invention;

FIG. 3 is a block diagram of a system comprising a device and a component providing voice recognition capabilities for operating device, in accordance with some embodiments of the present invention;

FIG. 4 is a high level dataflow diagram depicting computational flow of generating control instructions for operating a device without a network interface, in accordance with some embodiments of the present invention;

FIG. 5 is a flowchart depicting a computer implemented method for analyzing audio for generating comments to operate a device without a network interface, in accordance with some embodiments of the present invention; and

FIG. 6 includes examples of circuit diagrams for implementing features of offline voice recognition capabilities for operating a device, in accordance with some embodiments of the present invention.

### DETAILED DESCRIPTION

The present invention, in some embodiments thereof, relates to voice recognition and, more specifically, but not exclusively, to voice recognition built into consumer products.

As used herein, the terms matching and measuring similarity, between features extracted from the audio signals and (features extracted from) the text file, may sometimes be interchanged.

As used herein, the term offline, such as offline component for providing voice recognition, and/or offline voice recognition, refers to the ability to operate a device using voice commands without a network interface, i.e., without communicating with an external server or cloud. The voice recognition may be done entirely on-chip, and/or within an embedded system, without using a network connection to access an external device and/or external service.

An aspect of some embodiments of the present invention relates to devices that include built-in voice recognition capabilities without requiring communication abilities, for example, without requiring wireless network connection such as Wi-Fi access and/or internet access. Devices may be consumer products found commonly in the home, for example, lights, speakers, portable heaters, fans, coffee makers, food grinders, and the like.

An aspect of some embodiments of the present invention relates to components, methods, and/or code (stored on a memory and executable by one or more processors) for providing voice recognition capabilities for operating a device. The component may include a memory for storing a text file(s) including command(s) for operating the device. The component may include a microphone that generates audio signals in response to a user speaking. The component includes circuitry (e.g., one or more processors executing code stored on a memory, and/or hardware implementing the code) in communication with the memory and the microphone. The circuitry extracts features from audio signals generated by the microphone. The circuitry compares the extracted features to the command(s) of the text file stored by the memory. For example, the features extracted from the audio signals are arranged as a first vector. Features may be extracted from the commands of the text file, and arranged as a second vector. The comparison may be done by measuring similarity between the first and second vector, for example, a correlation between the vectors and/or statistical distance between the vectors (e.g., Euclidean distance). A correlation values above a threshold and/or distance between a threshold indicates a match, i.e., that the spoken speech matches one of the commands. In response to a match between the features and the command(s), instructions are generated (e.g., issued) for operating the controller according to command(s).

At least some implementations of the devices described herein address the technical problem of improving voice recognition capabilities that are built-in to devices such as consumer applications. The technical problem may relate to security vulnerability of devices that are continuously connected to the outside world, such as the internet and/or other wireless network as part of their built-in voice recognition capabilities. At least some implementations of the devices described herein improve the technical field of voice recognition technology, by providing voice recognition capabilities that are built-in to devices such as consumer applications, without requiring a network connection, such as a wireless network interface for wireless communication. The improvement may relate to improved security of the devices as a result of lacking the network connection, thus preventing an entry point for a malicious entity attacking the device. At least some implementations of the devices described herein improve upon prior approaches for implementing voice recognition technology, which require a network connection, such as a wireless network interface for wireless communication.

Existing devices with built-in voice recognition capabilities rely on a network connection, usually a wireless network connection, for example, Wi-Fi and/or internet access. Voice recognition capabilities are provided by a centralized server and/or cloud based service, which requires the network connection to operate. The network connection may be further used, for example, for receiving regular updates, introducing new features, improving existing functionalities, expanding compatibility with third-party services, and/or continually refining machine learning models to enhance speech recognition accuracy and user experience.

The network interface of existing devices with built-in voice recognition capabilities presents a security vulnerability. Such devices may be hacked by malicious entities accessing the device with the network connection, for example, over the internet and/or over a local wireless network. Existing approaches to secure such devices include, for example, features like mute buttons and privacy settings. In another example, existing voice command technologies often incorporate encryption measures to secure the communication between the device and the cloud servers, ensuring that sensitive information is protected.

At least some embodiments described herein address the aforementioned technical problem, and/or improve upon the aforementioned technical field, and/or improve upon the aforementioned existing approaches, by providing voice recognition capabilities for operating a device, such a consumer product, without requiring networking and/or external communication capabilities, i.e., offline voice recognition capabilities. The offline voice recognition capabilities may be built-in to the device. The offline voice recognition capabilities described herein are resilient to unavailability of a network (e.g., when the network is down and/or in geographical locations where there is no wireless and/or cellular service). The offline voice recognition capabilities are secure, since there is no network access that a malicious entity can use.

Circuitry described herein that operates the generic offline voice recognition capabilities may be designed to be generic yet capable of operating with few processing resources. The circuitry described herein may provide voice capabilities to any user for any device for any operation, by small hardware, within a reasonable amount of processing time (e.g., less than about 1 second, or 2 seconds, or other values).

At least some implementations of the devices described herein address the technical problem of increasing a number of available commands for operating a device.

At least some implementations of the devices described herein address the technical problem of customizing commands for operating a device.

At least some embodiments described herein address the aforementioned technical problem, and/or improve upon the aforementioned technical field, and/or improve upon the aforementioned existing approaches, by using a memory storing a text file with multiple commands for the device. Measuring similarity between features extracted from the audio file and features extracted from commands of the text file is a generic process that does not limit the number of commands and/or the nature of the commands. The text file may store a large number of commands for the device, for example, over 5, 7, 10, or other number. By measuring similarity between features extracted from the audio file and features extracted from commands of the text file, the number of commands is not limited. Moreover, the commands themselves may be dynamically changed, for example, new commands may be introduced. In addition, the commands for the memory may be customized, for example, by mapping text commands to digital signals for operating the device, and/or identifiers of the device may be customized. For example, instead of using the term “turn on” to turn on an air conditioner, a user may define the command “It's hot in here!” to turn on the air conditioner.

At least some implementations of the devices described herein address the technical problem of improving a user experience of using voice activated devices. Using existing approaches where the voice activation is based on a wireless network connection to a server and/or computing cloud, a user first requires wireless access from their home. Some populations, such as elderly, physically challenged, and/or those in remote locations (e.g., camping) may not be able to set up such wireless networks and/or may not be able to connect their device to a wireless network, thereby preventing them from using such voice activated devices. At least some embodiments described herein address the aforementioned technical problem, and/or improve a user experience in using voice activated devices, by proving the off-line voice recognition capability described herein, which does not require the user to set-up and/or connect to a wireless network. Devices enhanced with the off-line voice recognition capability (e.g., component) described herein may be used by a user immediately, without requiring the user to setup and/or connect to a wireless network.

At least some embodiments described herein address the technical problem(s) by relating to an offline voice-activated firmware product using voice commands to activate appliances (i.e., devices). Without the need for Wi-Fi, a smart plug, a phone or an app, it is simple to plug into an AC outlet and use. This allows products (i.e., devices) to be used in remote environments and privacy kept. No data storage and forwarding is needed. A smart product done simply. The firmware actions created are beyond a simple turn-on or turn-off. There may be an activation word, which for example, the name of the product “heater”+the word for example “boss.” When the user says “Heater Boss”, the heater termed “boss” is turned on. The user may provide other commands, for example, keep me warm for 3 hours, increase temperature, cool mode, swing on/off, turn on light, disco mode . . . etc. Action in response to the activation word may be, for example, beep once and blinks if appliance matches the keyword. Action in response to the command: the product may reacts and follow a defined action tree. Deactivation actions: for example, double beep or double blink light. In some embodiments a fully on non-voice activation mode may be turned on by holding down a mode key for about 5 seconds (or other time).

At least some embodiments described herein address the technical problem(s) by making voice-activated products (i.e., devices) simple. Easy to set, just an AC outlet is needed, or the device may be batter powered. A product to command without the need for the internet is provided. The voice controls may be similar on a decision/action tree for each product, with enabling customization as required/desired. This is designed to make it easy for consumers to use. Firmware may be embedded into PCB chips that may be used and/or customized per product. Embodiments described herein may be different than an accessory like a smart plug, but instead may be designed to be inserted cleanly into the product (i.e., device). This is designed to allow consumers to an easy-to-use experience, without set up with a computer interface.

At least some embodiments described herein address the technical problem(s) by following a different path of basic commands, which may be low tech. Products (i.e., devices) described herein may operate immediately when plugged in, ready for commands, in contrast to many devices that are so smart, a user needs to set up, register, enter Wi-Fi password and/or log into accounts. When doing this, the user shares what product they bought on what day, does the user's internet have enough bandwidth and product many times collects, stores and shares data, which may be a security risk and/or breach of privacy. The device described herein makes the appliance simply work and the user chooses actions.

At least some embodiments described herein address the technical problem(s) by requiring only an AC Outlet and/or battery, and can use offline more than 1 command. No internet, app, smart plug is needed. No programming/set up time, collecting data is needed. The device may be designed to enable multi-generational use—8 to 80+ years. The device may be used in remote Areas. The device provides offline usage and/or maintains privacy.

An example of use of the device according to some implementations is now described. The device may be a heater with ambient light that can be commanded to turn on when relaxing and/or when a user has their hands full. The user may ask the heater to turn on, increase temperature, keep me warm for 8 hours, turn on light, when walking to the bathroom and the like. In another example, the device may be a fan, that the user can operate verbally for putting into sleep mode, turning on and off with natural breeze mode and setting timer for as little as an hour up to 12. In yet another example, the device is coffee maker, that user can verbally request to make coffee and/or set to make coffee up to 12 hours.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

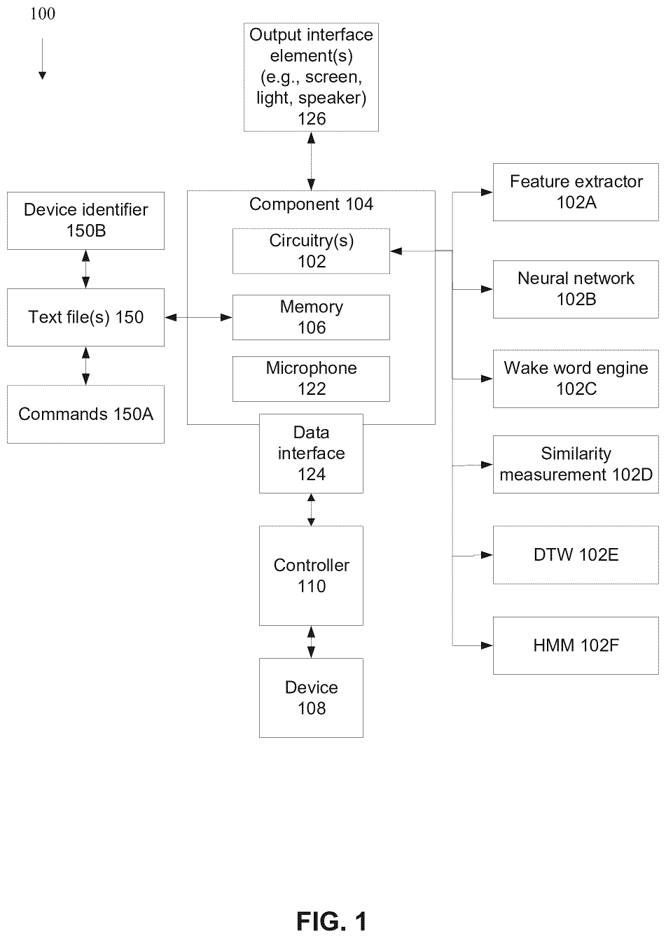

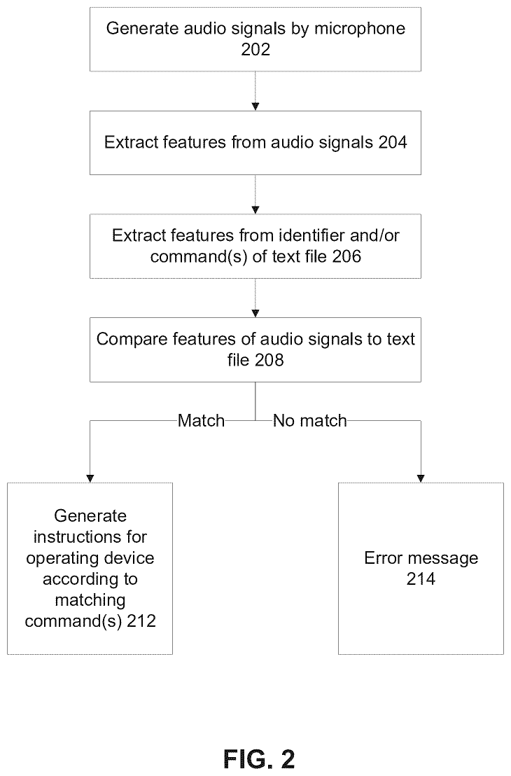

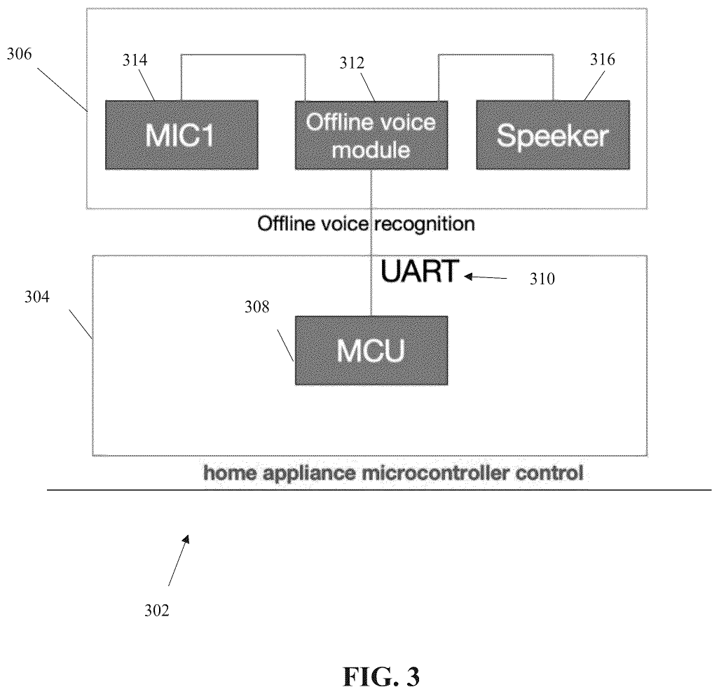

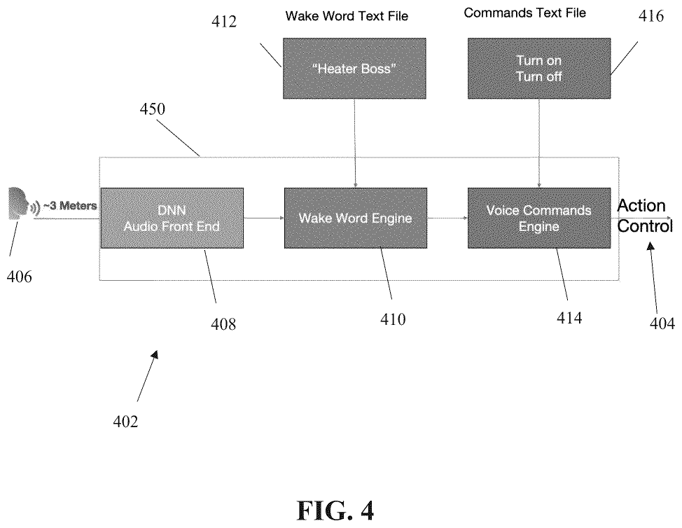

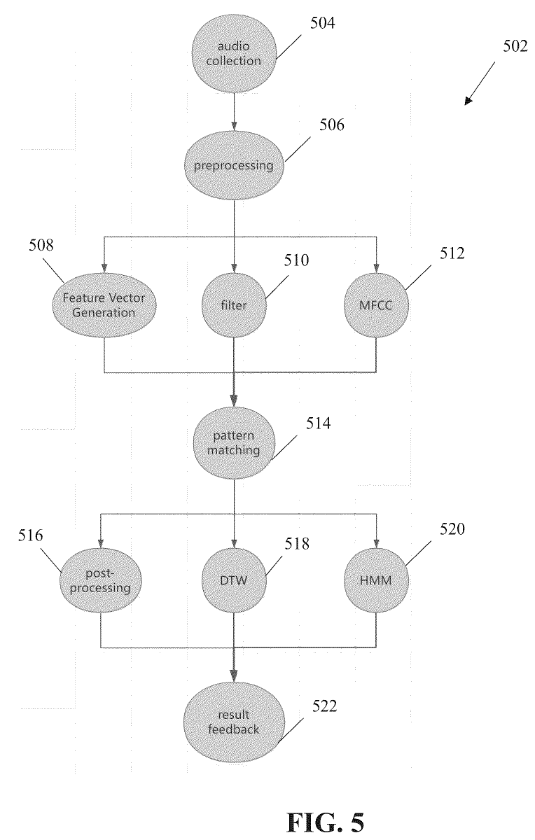

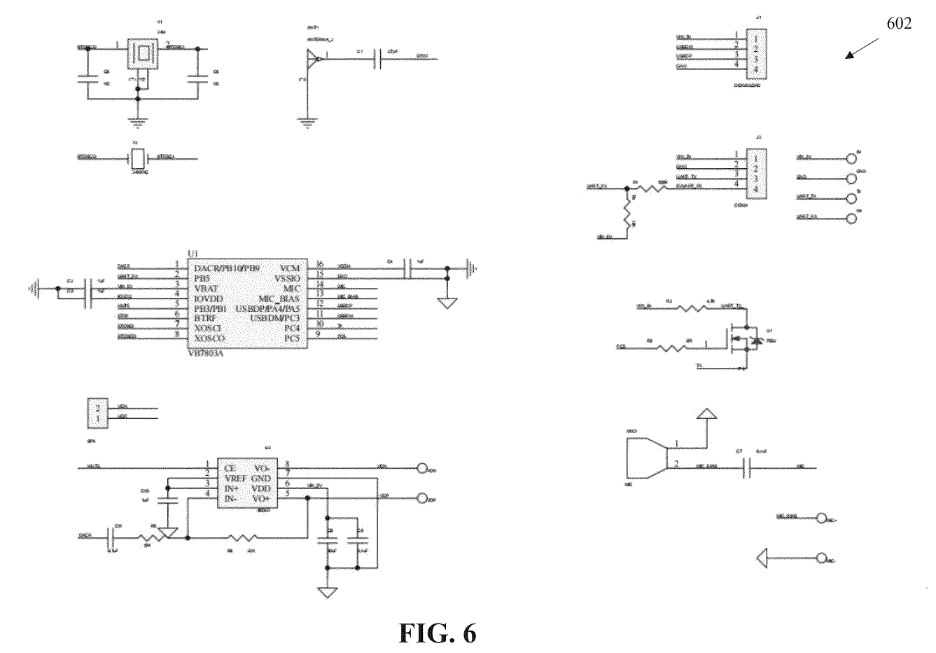

Reference is now made to FIG. 1, which is a block diagram of a system 102 comprising a device 104 and a component 106 designed for providing offline voice recognition capabilities for operating device 104, in accordance with some embodiments of the present invention. Reference is also made to FIG. 2, which is a flowchart of a method for providing offline voice recognition capabilities for operating a device, in accordance with some embodiments of the present invention. Reference is also made to FIG. 3, which is a block diagram of a system 302 comprising a device 304 and a component 306 providing voice recognition capabilities for operating device 304, in accordance with some embodiments of the present invention. Reference is also made to FIG. 4, which is a high level dataflow diagram 402 depicting computational flow of generating control instructions 404 for operating a device without a network interface, in accordance with some embodiments of the present invention. Reference is also made to FIG. 5, which is a flowchart 502 depicting a computer implemented method for analyzing audio for generating comments to operate a device without a network interface, in accordance with some embodiments of the present invention. Reference is also made to FIG. 6, which includes examples of circuit diagrams 602 for implementing features of offline voice recognition capabilities for operating a device, in accordance with some embodiments of the present invention.

Referring now back to FIG. 1, component 104 may be implemented as, for example, a card that is inserted into a slot of device 108, integrated with device 108 (e.g., control panel of device 108 is opened, and wires of device 108 are soldered in place of wires of the control panel), a separate enclosed component (e.g., box) that plugs into device 108, hardware that is connected to device 108, and integrated within a controller 110 of device 108 as an embedded system installed within device 108, and the like.

Component 104 includes a data interface 124 in communication with controller 110 of device 108.

Data interface 124 may be designed for point to point communication between component 104 and controller 110. Data interface 124 may be physically wired to the controller of the device, for example, using wires and/or a bus. Data interface 124 may be implemented as a serial interface. Data interface 124 may implemented a hardware communication protocol, optionally for serial communication, over short distances. For example, Universal Asynchronous Receiver/Transmitter (UART). UART may be used to connect components on a circuit board or to communicate between different devices over short distances. The UART communication involves two pins, one for transmitting data (TX) and another for receiving data (RX). It operates asynchronously, meaning that there is no separate clock signal shared between the devices. UART is a widely used and versatile communication protocol, providing a simple and effective way for devices to exchange data serially. It is noted that other suitable communication protocols may be used.

Component 104 may exclude a network interface. Alternatively, component 104 may include the network interface (e.g., for obtaining local updates of code) but is able to operate off-line without relying on the network interface.

Device 108 may include, for example, a consumer product, a home device, a coffee maker, heater, fan, vacuum, lights, diffusers, radio, oven, speakers, audio devices, video devices, television, personal care devices, air conditioners, and the like.

Device 108 may include a controller 110 that controls operation of device 108, for example, a microcontroller, physical switches with electrical wiring, and the like.

Component 104 includes circuitry 102, for example, a processor(s) that executes code stored on a memory 106 (or another memory and/or data storage device) and/or hardware implementation of code instructions and/or that runs firmware. Circuity 102 may be implemented for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 is designed for storing one or more text files 150 of commands 150A for operating device 108 and/or identifier(s) 150B of device 108. It is noted that text file is used as a common example of a representation for storing text, and is not necessarily limiting, as other implementations may be used. Other implementations may include to a conversion of text into another representation.

It is noted that identifiers 150B may not necessarily be of device 108, but of another unique entity, for example, a user. Identifier 150B may be of a user. For example, in a room with different lights, each of a different user, the identifier may be for the different users.

Memory 106 may store code instructions for execution by circuitry 102.

Memory 106 may be implemented as, for example, a random access memory (RAM), a read-only memory (ROM), and/or a storage device, for example, non-volatile memory, magnetic media, semiconductor memory devices, hard drive, removable storage, and optical media (e.g., DVD, CD-ROM).

The text file 150 may store a large number of commands 150A for the device, for example, over 5, 7, 10, or other number.

Examples of commands 150A for a fan include: turn on, turn off, swing on, swing off, set time for 2 hours, set timer for 4 hours, set time for 8 hours. Commands may be customized (e.g., “fun”), for example: let's chill (turns on), it's too hot (increase fan speed), keep me cool for 2/4/8 hours.

Examples of commands 150A for a heater include: turn on/off/shut off, I am cold (turn on), warm me up (turns on), raise temperature, cool mode, light on/off, disco mode/light change, swing on/off, set times for 2/4 hours, keep me warm for 4/8 hours.

Examples of commands 150A for a coffee maker include: make coffee, caffeinate me.

Examples of commands 150A for a diffuser include: turn on/off/shut off, let's chill (turns on), light on/off, disco mode, light change, set time 1/2/4 hour, freshen my room for 1/2/4 hour.

Examples of device identifiers 150B include the common name of the device and/or a unique identifier for the device, for example, David's fan, large air conditioner, office coffee maker, and the like.

Component 104 includes one or more microphones 122, that generate audio signals in response to a user speaking. Microphone 122 may generate audio and/or digital signals.

Component 104 may include one or more output interface elements 126, for example, that generate an indication of whether the command has been successfully implemented by device 108, or whether there is an error (e.g., commands does not exist). Output interface element(s) 126 may include, for example, a screen presenting messages and/or videos and/or images, speakers playing sounds and/or audio message, lights, and the like.

Circuitry 102 may implement one or more features described herein in hardware and/or firmware. Alternatively or additionally, one or more features described herein may be implemented as code instructions stored on a memory (e.g., memory 106) for execution by a processor of circuitry 102. Examples of features include: feature extractor 102A for extracting features from the audio signals and/or text file 150A, neural network 102B for extracting features as an embedding and/or converting audio signals to digital, wake word engine 102C, similarity measurement 102D for determining whether the audio signal matches a command 150A and/or identifier 150B, DTW 102E, HMM 102F, and the like.

As used herein, the term neural network, and/or HMM are examples of machine learning models and/or statistical models, and are not necessarily limiting. Other suitable implementations for performing functions described herein may be used, for example, statistical classifiers and/or other statistical models, neural networks of various architectures (e.g., convolutional, fully connected, deep, encoder-decoder, recurrent, graph, transformer), support vector machines (SVM), logistic regression, k-nearest neighbor, decision trees, boosting, random forest, a regressor, and/or any other commercial or open source package allowing regression, classification, dimensional reduction, supervised, unsupervised, semi-supervised and/or reinforcement learning. ML models may be open source and/or publicly available models, and/or customized models.

Referring now back to FIG. 2, features of the method described with reference to FIG. 2 may be implemented by components of the system described with reference to FIGS. 1, 3, 4, and/or 6. Features of the method described with reference to FIG. 2 may be combined with, replaced with, and/or augmented with, features of the method described with reference to FIG. 5.

At 202, audio signals generated by the microphone are accessed and/or obtained.

Optionally, the audio signals generated by the microphone are analogue. The analogue signals may be digitized, for example, by a sampler, a trained neural network, and the like. Alternatively, the microphone generates digital audio signals. Alternatively, the analogue signals are not digitized, but are analyzed in their analogue form.

Optionally, the audio signals are pre-processed. For example, a dynamic time warping (DTW) of the audio signal and the text file is computed, for alignment of temporal sequences of the audio signal and the text file vary in speed.

At 204, features are extracted from the audio signals.

The features may be extracted by a machine learning model, for example, a neural network or other architecture described herein.

The features may be extracted from the neural network as embeddings, for example, from a hidden layer of the neural network, and/or by removing one or more of the last layers of the neural network after the neural network has been trained.

The machine learning model (e.g., neural network) may be trained for each type of device. Alternatively or additionally, the machine learning model may be generically trained for different devices, which may have overlapping commands such as “turn on”.

The machine learning model (e.g., neural network) may be trained on a training dataset of multiple records. Each record may include a sample audio signals saying one of the commands and/or identifiers of the text file. The record may include the corresponding text command and/or identifier. The corresponding text command and/or identifier may be labelled as a ground truth. The sample audio signals of the training dataset may be obtained from multiple different individuals, for example, of different genders, different ages, and/or of different physical and/or emotional states (e.g., sick, well, tired, hungry, lost voice, angry, sad, flat, and the like).

The audio signals may be computed from a time domain to a frequency domain, for example, by a Fourier Transform such as a Fast Fourier Transform (FFT).

Optionally, one or more of the extracted features include Mel Frequency Cepstral Coefficients (MFCCs). The MFCCs may be computed by applying a Mel filterbank to a power spectrum representation of the audio signal (e.g., Fourier transform), computing a logarithm of the outcome of applying the Mel filterbank, and applying a discrete cosine transform (DCT) to obtain the MFCCs.

Alternatively or additionally, one or more of the extracted features may relate to one or more observations (e.g., extracted patterns). generated as outcomes of applying a trained Hidden Markov Model (HMM) to the audio signals.

The features may be arranged as a feature vector.

At 206, features may be extracted from the text file, i.e., from the identifiers and/or commands.

The features may have been pre-extracted and stored on the memory. Alternatively or additionally, the features may be dynamically extracted in response to receiving the audio signals. For example, when different types of features are extracted from the audio such as based on an analysis of the audio signals, the features extracted from the text file may be selected to correspond to the features extracted from the audio signals.

The features extracted from the text file may selected to enable matching to features extracted from the audio file, and/or to enable computing similarity with features extracted from the audio file.

Optionally, features extracted from the text file are arranged as a vector. The vector of features extracted from the text time may be in a same space as a vector of features extracted from the audio file. For example, Word2Vec may be used to convert text into vector representation.

Alternatively or additionally, the text file may be used as-is, without necessarily extracting features. For example, audio signals may be converted into text, for example, by an automatic speech recognition process (ASR). The converted text may be compared to the text of the text file, for example, using text comparison approaches.

Alternatively or additionally, the text file is converted into an audio representation. The audio representation of the text may be compared to the audio signals, for example, using DTW and/or HMM and/or other approaches for comparison of two temporal sequences.

At 208, the features extracted from the audio signals are compared to the text file, optionally to the features extracted from the text file. The comparison may be done per identifier and/or per command of the text file, to find a match.

The comparison may be done by one or more approaches, such as according to a threshold and/or requirement, for example:
Arranging features extracted from the audio signals are a first vector. Arranging features extracted from the text file as a second vector. The first vector and the second vector are within a common space. Computing a distance between the first vector and second vector, for example, a Euclidean distance. A distance less than a threshold indicates a match, i.e., that the speech spoken by the user refers to the identifier and/or command of the text file.
Computing a correlation between the features extracted from the audio signals and features extracted from the text file. A correlation value above a threshold may indicate a match.
Measuring a similarity between the features extracted from the audio signals and features extracted from the text file. A similarity value above a threshold may indicate a match.
Matching between the features extracted from the audio signals and features extracted from the text file. A number of matches above a threshold may indicate a successful match.
Matching and/or measuring similarity between a text representation of the audio signals and the text file.
Matching and/or measuring similarity between the audio signals and an audio representation of the text file.

Optionally, the comparison of the features of the audio signal are compared first compared to the identifier(s) of the text file. The identifiers may represent a signature of the device which may be unique to the type of device. For example, the identifier may be “light” to distinguish from other voice recognition enabled devices in near proximity (e.g., vacuum cleaner, coffee maker, fan). The identifiers may represent a signature of the device which may be unique to the specific instance of the device. For example, the identifier may be “light over sofa” in a room with multiple different lights. Initially matching the identifier may help prevent inadvertent and/or unintended operation of other devices having same commands. For example, turning on a light, as intended, but at the same time activating the coffee maker and fan, which are undesired.

Optionally, in response to a successful match with the identifier, a comparison between the audio signals (e.g., feature extracted therefrom) and a command of the text file is evaluated.

At 212, in response to a match between the audio signals (e.g., features extracted from the audio signals) and a certain command (e.g., features extracted from the text of the command), the device is operated according to the command. The controller of the device may be instructed according to the command. The controller may operate the device

Optionally, the circuitry generates instructions for operating the device and/or controller according to the command. Each command of the text file may be associated with predefined instructions. The circuitry may send the predefined instructions to the device and/or controller according to the command matching the audio signals. The instructions may be, for example, signals, and/or code

Alternatively or additionally, the circuitry may directly operate the device and/or controller. For example, the circuitry is hard wired to the control panel of the device, for example, in place of manual buttons and/or switches. In response to a match, the circuitry may send an electrical signal to the wire of the button/switch corresponding to the matching command.

Optionally, the output interface element(s) is activated, indicating a successful match. For example, a green light is turned on, a verbal comment (e.g., “operating”) is played over the speakers, and/or a message/image is presented on the display (e.g., indicating what command has been implemented).

At 214, in response to no match being found, the output interface element(s) may be activated to indicate error, and/or to try again, optionally with instructions on how to improve such as to say it louder, slower, and/or closer to the device. For example, a green light is turned on, a verbal comment (e.g., “I did not understand what you said, please repeat again slowly”) is played over the speakers, and/or a message/image is presented on the display (e.g., indicating that the command has not been understood and/or device does not exist).

Referring now back to FIG. 3, components described with reference to FIG. 3 may be implemented by, and/or may be used in combination with, and/or may be replaced by, one or more components described with reference to FIG. 1.

Device 304 may be, for example, a consumer product, appliance, and/or device commonly found in the home. Examples of devices 304 include lights, speakers, air conditioner, television, radio, portable heaters, coffee makers, food grinders, and the like.

Device 304 includes a controller 308, for example, a microcontroller unit (MCU). As used herein, the term MCU is not necessarily limiting, and interchangeable with the term controller, and meant to encompass different suitable implementations. MCU 308 may include one or more processors, memory, and/or communication interfaces 310 for local connectivity to component 306. Communication interface 310 may implement a hardware communication protocol used for serial communication between devices. Communication interface is designed for transmitting and receiving data (e.g., serial data) between controllers (e.g., microcontrollers), sensors, modules, and other electronic devices. Communication interface 310 excludes a network interface that provides communication with an external network. Communication interface 310 may be implemented, for example, as a Universal Asynchronous Receiver/Transmitter (UART). The term UART is not necessarily limiting, and interchangeable with the term communication interface, and meant to encompass different suitable implementations for communication between a controller and device. Examples of other communication interfaces 310 include SPI, and I2C.

Communication interface 310 provides communication with component 306.

Component 306 may be implemented as circuitry, a card, and/or a box, that is integrated within device 304 and/or in locally connected to device 304 (e.g., plug-in, locally attached, located within).

Component 306 includes an offline voice module 312, that generates instructions for controller 308 in response to voice commands sensed by a microphone 314. Offline voice module 312 may be in communication with one or more speakers 316, for example, for playing audio messages to a user, such as instructions for how to train offline voice module 312 to generate instructions based on the user's voice.

Referring now back to FIG. 4, dataflow 402 described with reference to FIG. 4, may be implemented by and/or may be used in combination with, and/or may be replaced by, one or more components described with reference to FIG. 1, and/or may be based on, and/or replaced with, and/or in combination with, features of the method described with reference to FIG. 2.

Dataflow 402 may be implemented by components 408, 410, and 414 of an instance of a voice recognition component 450 associated with a specific device (not shown). Components 408, 410, and/or 414 may be implemented as circuitry, for example, as shown with reference to FIG. 6. Components 408, 410, and/or 414 may be implemented based on components described with reference to FIG. 1.

Speech generated by a user 406 may be digitized and/or pre-processed into a format suitable for being fed into a machine learning model 408, for example, a deep neural network (DNN). ML model 408 generates output which may be fed into a wake word engine 410. Wake word engine 410 may access a reference dataset 412, optionally implemented as a text file (e.g., referred to herein as a Wake Word Text File). The wake word may be a identifier assigned to the device being operated. Wake word engine 410 may compare the input received from DNN 408 to the identifier in dataset 412. A match indicates that the speech by the user is directed towards the specific device associated with the specific implementation of the voice recognition component 450. The wake word engine 410 may help ensure that in a scenario of a user speaking in near proximity to multiple different devices, the device to which the user is directing their speech is operated, while other devices ignore the speech. For example, as shown, wake word text file 412 includes the identifiers “Heater Boss”, where the term “Heater” may be for multiple different heaters, and the term “Boss” may be specific for the intended device. When the user says turn on heater boss, wake word engine 410 identifies that the user is referring to the specific connected device. Another wake word engine of another device such as a speaker and/or another heater, will ignore the speech by determining that the user is not referring to the speaker and/or heater, but to a different device such the specific heater.

In response to a match by wake word engine 410, the outcome of the ML model 408 may be fed into a voice commands engine 414. Voice commands engine 414 may analyze the outcome of the ML model 408 to identity commands for operating the device. The analysis may be performed by attempting to match the outcome of the ML model 408 to one or more identifiers in a dataset 416, for example, words in a text file (e.g., referred to herein as a Commands Text File). Each identifier may be associated with specific instructions (e.g., signals, code) which are outputted for operating the device, such as provided to the controller of the device. For example, the commands text file may include the phrases “Turn on”, and “Turn off”, each associated with specific signals. When the voice commands engine 414 identifies that the user said “turn off”, voice command engine 414 triggers action 404 for turning off the heater boss.

Referring now back to FIG. 5, features described with reference to FIG. 5, may be implemented by and/or may be used in combination with, and/or may be replaced by, one or more components described with reference to FIG. 1 and/or FIG. 3, and/or may be based on, and/or replaced with, and/or in combination with, features of the method described with reference to FIG. 2 and/or FIG. 4.

At 504, audio is collected. Audio is collected by a microphone.

At 506, the audio is preprocessed.

The processing may include, for example, one or more of:
Conversion of an analogue representation of the audio to digital representation.
Dividing the audio into short frames, for example, about 20-30 milliseconds or other lengths. Frames may overlap. The overlapping frames may be used to capture temporal information.
Formatting the audio into a format suitable for being fed into a ML model.
The audio signal and/or each frame may be multiplied by a window function (e.g., Hamming window) to reduce spectral leakage and emphasize the central part of the frame.
The audio signal and/or frames may be transformed from the time domain to the frequency domain using a Fast Fourier Transform (FFT) to compute a spectrum representation for the audio signal and/or for each frame.

At 508, a feature vector may be generated from the preprocessed audio, for example, as described herein.

The preprocessed audio may be fed into the ML model, which generates the feature vector as an outcome.

At 510, the audio may be filtered, for example, to remove background noise.

Higher frequencies in the audio signal may be boosted to balance the frequency spectrum, optionally by applying a high-pass filter to the audio signal.

At 512, features may be extracted from the audio, for example, Mel-Frequency Cepstral Coefficients (MFCC) may be extracted. MFCCs may be derived from the Mel-frequency scale, which approximates the human ear's sensitivity to different frequencies. The MFCC extraction process may involve several steps to represent the spectral characteristics of audio signals in a more compact and discriminative manner. MFCC may be computed by applying a Mel filterbank to the power spectrum, taking the logarithm of the outcome of applying the Mel filterbank, and applying a discrete cosine transform (DCT) to obtain the MFCC.

It is noted that features described with reference to 508, 510, and/or 512 may be implemented in parallel, sequentially in any order, and/or in a combination. For example, the feature vector computed in 508 may include the MFCCs computed in 512.

At 514, features extracted according to 508 and/or 512, and/or the filtered features and/or filtered audio 510, may be analyzed to determine whether there is a match with a pattern extracted from the text file. The pattern may be an identifier associated with the specific device and/or instructions for operating the specific device.

Additional exemplary approaches for matching are described herein.

At 516, post processing may be performed.

The extracted features and/or filtered audio signals and/or MFCCs may be normalized to improve robustness against variations in input conditions. Examples of normalization techniques include mean and variance normalization.

At 518, dynamic time warping (DTW) may be performed, for example, as described herein. DTW may be used to measure the similarity between two sequences that may vary in time or speed. DTW may be used when comparing sequences that have different lengths, and it can align them in a way that allows for meaningful comparisons, even if they exhibit temporal distortions.

At 520, a statistical model, for example, the hidden markov model (HMM), may be applied, for example, as described herein.

It is noted that features described with reference to 516, 518, and/or 520 may be implemented in parallel, sequentially in any order, and/or in a combination.

At 522, the instructions for operating the device may be generated. The instructions may be locally sent to the device, as described herein. Alternatively, feedback may be provided to the user such as played over audio speakers, for example, indicating that there was no match to the device and/or no match to known instructions.

Referring now back to FIG. 6, examples of circuit diagrams 602 for implementing features of offline voice recognition capabilities for operating a device, as depicted. Circuitry diagrams 602 may implemented different features described herein, for example, with reference to FIGS. 1-5.

The methods as described above are used in the fabrication of integrated circuit chips.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant components and devices will be developed and the scope of the terms components and device are intended to include all such new technologies a priori.

As used herein the term “about” refers to ±10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A component for providing offline voice recognition capabilities for operating a device, comprising:
a memory configured to store a text file including at least one command for operating the device;
a microphone; and
circuitry in communication with the memory and the microphone, the circuitry configured for:
extracting features from audio signals generated by the microphone;
comparing the features to the at least one command of the text file stored by the memory; and
in response to a match between the features and the at least one command, generating instructions for operating the device according to the at least one command.

2. The component of claim 1, wherein comparing comprises measuring similarity between the features and the at least one command, and the match comprises the measured similarity is greater than a threshold and/or according to a requirement.

3. The component of claim 1, wherein the component excludes a network interface.

4. The component of claim 1, wherein the component includes a data interface for point to point communication between the component and a controller of the device.

5. The component of claim 4, wherein the data interface is physically wired to the controller of the device.

6. The component of claim 4, wherein the data interface is a serial interface.

7. The component of claim 1, wherein the device comprises at least one of: a consumer product and a home device.

8. The component of claim 1, wherein the device is selected from: coffee maker, heater, fan, vacuum, light, diffuser, radio, oven, speaker, audio device, video device, television, personal care devices, and air conditioners.

9. The component of claim 1, wherein the component is integrated with a controller of the device as an embedded system installed within the device.

10. The component of claim 1, wherein the circuitry is further configured for implementing a neural network that generates an embedding in response to an input of the audio signals, the extracted features include the embedding.

11. The component of claim 10, wherein the neural network is trained on a training dataset of multiple sample audio signals from a plurality of individuals referring to a plurality of different identifiers of devices and/or a plurality of different commands for operating the device.

12. The component of claim 1, wherein the memory is further configured to store a second text file including at least one identifier of the device,
wherein circuitry is further configured for comparing to features to the at least one identifier of the device; and
in response to a match between the features and the at least one identifier, performing the comparison between the features and the at least one command.

13. The component of claim 1, further comprising circuitry for extracting features from the text file, wherein the comparison is done by comparing the features extracted from the audio signals to features extracted from the text file.

14. The component of claim 13, wherein features are extracted from the audio signals as embeddings arranged into a first vector outputted by a neural network, and features are extracted from the text file as a second vector, and the comparison is performed by computing a distance between the first vector and the second vector, and evaluating the distance according to a threshold or requirement.

15. The component of claim 1, wherein at least one of the extracted features includes Mel Frequency Cepstral Coefficients (MFCCs) computed by applying a Mel filterbank to a power spectrum representation of the audio signal, computing a logarithm of the outcome of applying the Mel filterbank, and applying a discrete cosine transform (DCT) to obtain the MFCCs, wherein the MFCCs are compared to the text file.

16. The component of claim 1, wherein the comparison is performed by computing a dynamic time warping (DTW) of the audio signal and the text file for alignment of the audio signal with the text file for matching the aligned audio signal and text file by measuring similarity between temporal sequences of the matched aligned audio signal and text file varying in speed.

17. The component of claim 1, wherein the circuitry is further configured to implement a Hidden Markov Model (HMM) that obtains at least one observation in response to an input of the audio signals, and matching comprises assigning the at least one command to the at least one observation according to patterns extracted from the data.

18. The component of claim 1, wherein the text file includes at least 5 different commands for operating the device.

19. The component of claim 1, wherein the circuitry is further configured for digitizing an analogue signal obtained from the microphone, wherein the features are extracted from the digitized analogue signal.

20. A method of providing offline voice recognition capabilities for operating a device, comprising:
extracting features from audio signals generated by a microphone;
comparing the features to at least one command of a text file stored by a memory physically connected to the device; and
in response to a match between the features and the at least one command, generating instructions for operating a controller of the device according to the at least one command.

21. A non-transitory medium storing program instructions for providing offline voice recognition capabilities for operating a device, which when executed by at least one processor, cause the at least one processor to:
extract features from audio signals generated by a microphone;
compare the features to at least one command of a text file stored by a memory physically connected to the device; and
in response to a match between the features and the at least one command, generate instructions for operating a controller of the device according to the at least one command.
